(19) United States
(12) Patent Application Publication
(10) Pub. No.: US 2025/0315194 A1
(43) Pub. Date: Oct. 9, 2025

(54) IMAGE PROCESSING APPARATUS WITH VR IMAGE DISPLAY CONTROL FUNCTION, IMAGE PROCESSING SYSTEM, NON-TRANSITORY COMPUTER-READABLE MEDIUM, AND CONTROL METHOD OF IMAGE PROCESSING APPARATUS

(71) Applicant: CANON KABUSHIKI KAISHA, Tokyo (JP)

(72) Inventor: RURIKA SHIMIZU, Tokyo (JP)

(21) Appl. No.: 19/091,578

(22) Filed: Mar. 26, 2025

(30) Foreign Application Priority Data
Apr. 5, 2024 (JP) 2024-061802

(51) Int. Cl. G06F 3/14; G06F 3/0488

(52) U.S. Cl. CPC G06F 3/14; G06F 3/0488

(57) ABSTRACT

An image processing apparatus includes: a processor; and a memory storing instructions which, when executed by the processor, cause the image processing apparatus to: execute receiving processing for receiving an operation of changing a display range for an image displayed on a display; and execute display control processing for performing control based on the operation, the control being performed to transform an image of a predetermined range in a hemispherical image into a planar image and to display the planar image on the display. In the display control processing, the control is performed to display, in the display range, an area included in the planar image and corresponding to a predetermined area at least including an upper end position or a lower end position of the hemispherical image but not to display the area at a position of a center of the display range.

### BACKGROUND

### Field of the Disclosure

The present disclosure relates to an image processing apparatus with a VR reproduction function.

### Description of the Related Art

In recent years, virtual reality (VR) is widely used. Photographs and video are cited as VR content, and image capturing is performed by using, for example, an imaging device capable of: simultaneously acquiring a wide-angle image for the right eye and a wide-angle image for the left eye such as a hemispherical image for a stereoscopic view utilizing the parallax of both eyes; or capturing a wide-angle image such as a spherical image.

As captured VR content, an image acquired by perspective projection transformation is viewed mainly with an untransmissive head-worn display device (HMD), a display of a smartphone, a computer, or other devices. In the perspective projection transformation, part of a viewing area of a captured image is transformed. In particular, when the VR content of the captured image is viewed through the display of the smartphone, the computer, or other devices, the viewing area is changeable by a touch or operating a member such as a mouse or a button, and technology for controlling a viewable area is known. For example, in Japanese Patent Laid-Open No. 2022-84529, a viewable area is set within a captured image, and a viewing area outside the captured image can be undone to a viewable area viewed immediately before the change.

It is conceivable that if the VR content is a hemispherical image or an image with a captured image missing in a partial area, a user verifies whether unnecessary reflection is present particularly at an end of the captured image by viewing the end of the captured image located in the center of the captured image. However, in the technology disclosed in Japanese Patent Laid-Open No. 2022-84529 described above, the restriction of the viewable area to an area within the captured image causes the end of the captured image to be displayed only at an end of the viewing area, which prevents the verification with the end located in the center.

In contrast, a viewable area that is not restricted enables the end of the captured image to be verified with the end located in the center; however, as in FIG. 5C, an area outside the captured image is displayed in the viewing area. Such an area outside the captured image is typically expressed in such a manner as to be filled with black. In particular, assume that an operation for changing the viewing area by moving the viewing area in a right or left direction in a state where the viewing area has the upper and lower ends of the captured image and where the portion filled with black outside the captured image is displayed at the same time. In this case, the captured image and the portion filled with black outside the captured image are displayed in such a manner as to rotate and transit. Displaying in such a manner causes the image displayed on the screen to be changed drastically and thus causes deterioration in user's visibility. Further, the closer to the center of the captured image in the right and left directions the operation for changing the viewing area in the right or left direction is performed, the larger the degree of rotation of the image displayed in the viewing area becomes. It is thus difficult for the user to settle the viewing area in a desired location.

### SUMMARY

Hence, the present disclosure provides an image display device that has a viewable area in which if upper and lower ends of a captured image for VR content serve as upper and lower ends of a viewing area, and if the viewing area causes deterioration in the user's visibility or involves with difficult viewing area changing operation, restriction is put on the viewing area.

According to an aspect of the present disclosure, there is provided an image processing apparatus including: a processor; and a memory storing instructions which, when executed by the processor, cause the image processing apparatus to: execute receiving processing for receiving an operation of changing a display range for an image displayed on a display; and execute display control processing for performing control based on the operation, the control being performed to transform an image of a predetermined range in a hemispherical image into a planar image and to display the planar image on the display. In the display control processing, the control is performed to display, in the display range, an area included in the planar image and corresponding to a predetermined area at least including an upper end position or a lower end position of the hemispherical image but not to display the area at a position of a center of the display range.

Further features of the present disclosure will become apparent from the following description of exemplary embodiments with reference to the attached drawings.

### BRIEF DESCRIPTION OF THE DRAWINGS

FIG. 1A is a view of the external appearance of a display control apparatus.

FIG. 1B is a block diagram of the configuration of the display control apparatus.

FIG. 2A is a fish-eye image in VR content.

FIG. 2B is a view illustrating an area to undergo perspective projection transformation in the fish-eye image.

FIG. 2C is a view for explaining an image having undergone the perspective projection transformation.

FIG. 3A is a view for explaining correspondence between the fish-eye image and a hemisphere on the three-dimensional virtual space.

FIG. 3B is a view for explaining correspondence between the fish-eye image and the hemisphere on the three-dimensional virtual space.

FIG. 4 is a view illustrating the positions of a virtual camera on a three-dimensional virtual space in the hemispherical image and an area to undergo the perspective projection transformation.

FIG. 5A is a view in which a hemisphere is drawn on an area surrounded by a solid line on the three-dimension and a fish-eye image is attached to the inside thereof.

FIG. 5B is a top view of FIG. 5A, for explaining an image generated after the perspective projection transformation is performed on the three-dimensional virtual space in the hemispherical image.

FIG. 5C is an image after the perspective projection transformation of the fish-eye image viewed in an arrow (1) direction in FIG. 5A.

FIG. 5D is an image after the perspective projection transformation of the fish-eye image viewed in an arrow (2) direction in FIG. 5A.

FIG. 5E is an image after the perspective projection transformation of the fish-eye image viewed in an arrow (3) direction in FIG. 5A.

FIG. 5F is an image after the perspective projection transformation of the fish-eye image viewed in an arrow (4) direction in FIG. 5A.

FIG. 5G is an image after the perspective projection transformation of the fish-eye image viewed in an arrow (5) direction in FIG. 5A.

FIG. 6 is a flowchart illustrating processing according to one or more aspects of the present disclosure.

FIG. 7 is a flowchart illustrating processing according to one or more aspects of the present disclosure.

FIG. 8 is a view illustrating a restricted range of an area to undergo the perspective projection transformation according to one or more aspects of the present disclosure.

FIG. 9A is a view illustrating a restricted range of an area to undergo the perspective projection transformation according to one or more aspects of the present disclosure.

FIG. 9B is a view illustrating a restricted range of an area to undergo the perspective projection transformation according to one or more aspects of the present disclosure.

FIG. 10 is a flowchart illustrating processing according to one or more aspects of the present disclosure.

FIG. 11 is a view illustrating a reduced moving-amount range of an area to undergo the perspective projection transformation according to one or more aspects of the present disclosure.

### DESCRIPTION OF THE EMBODIMENTS

Hereinafter, embodiments will be described in detail with reference to the attached drawings. The following embodiments are not intended to limit the scope of the claims. A plurality of features are described in the embodiments, but limitation is not made to an embodiment that requires all such features, and the plurality of such features may be combined optionally. Furthermore, in the attached drawings, the same or similar components are denoted by the same reference numerals, and repeated description thereof is omitted.

### Embodiment 1

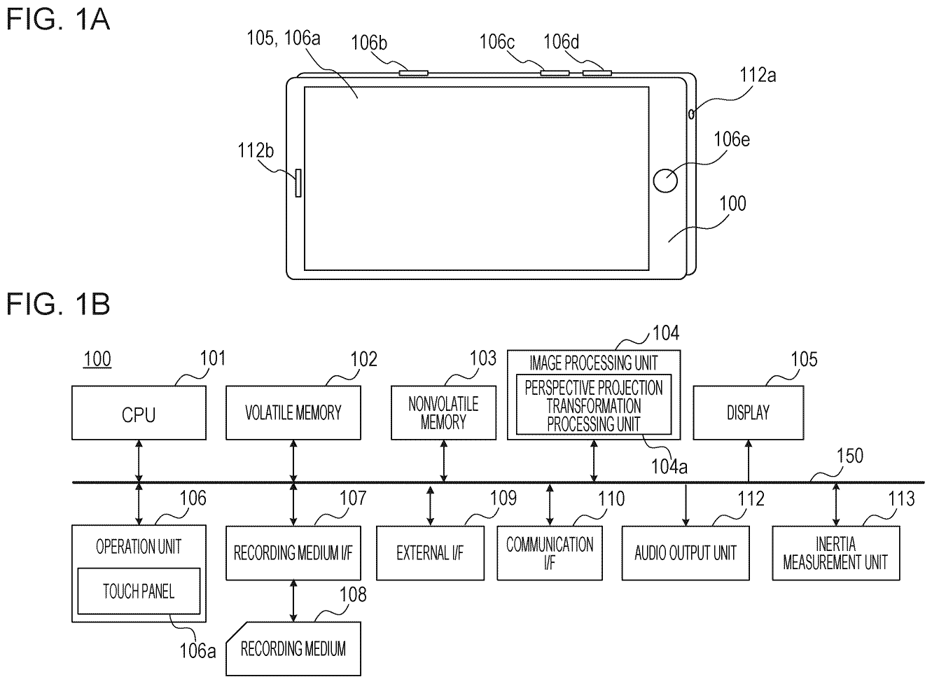

FIG. 1A illustrates an example external appearance view of a display control apparatus 100 that is a sort of an electronic apparatus.

A display 105 is a display unit that displays an image and various pieces of information. The display 105 is integrally formed with a touch panel 106a as to be described later and is configured to detect a touch operation on the display screen of the display 105. The display control apparatus 100 is capable of displaying a perspective projection transformation image on the display 105. The perspective projection transformation image is a planar image acquired by performing the perspective projection transformation of a photograph or video as VR content. The display style of the perspective projection transformation image is equivalent to a display style in viewing with a HMD and is hereinafter referred to as VR display.

An operation unit 106 includes the touch panel 106a and operation parts 106b, 106c, 106d, and 106e as illustrated in FIG. 1A. The operation part 106b is a power button that receives an operation for switching between powering on and off of the display control apparatus 100. The operation part 106c and the operation part 106d are buttons enabling various operations to be assigned. For example, it is possible to assign, in the VR display using the display 105, operations for changing a viewing area and an enlargement/reduction level and for increasing or decreasing the volume of sound output from an audio output unit 112. The operation for changing the enlargement/reduction level includes an enlarging operation and a reducing operation. The operation part 106e is a home button for displaying the home screen on the display 105. The operation unit 106 may be a device different from a display device and may also be an image processing system including a display device having at least a display unit and a controller having an operation unit for operating the display device.

An audio output terminal 112a is an earphone jack and a terminal through which sound is output to an earphone, an external speaker, or the like. A speaker 112b is a speaker that is built in the main body of the display control apparatus 100 and from which audio is uttered.

FIG. 1B illustrates an example configuration of the display control apparatus 100 as an example of an apparatus to which the present disclosure is applicable. A display control apparatus 200 may be configured by using a display device such as a smartphone.

In FIG. 1B, a CPU 101, a volatile memory 102, a nonvolatile memory 103, an image processing unit 104, the display 105, the operation unit 106, a recording medium I/F 107, an external I/F 109, a communication I/F 110, and the audio output unit 112 are connected to an internal bus 150. The components connected to the internal bus 150 are configured to be able to exchange data with each other via the internal bus 150.

The volatile memory 102 is composed of, for example, a RAM (a volatile memory or the like using a semiconductor device). The CPU 101 is a processor that performs control of the components of the display control apparatus 100 in accordance with a program stored, for example, in the nonvolatile memory 103, by using the volatile memory 102 as a working memory. The nonvolatile memory 103 stores image data, audio data, other data, various programs for causing the CPU 101 to operate, and the like. The nonvolatile memory 103 is composed of, for example, a hard disk (HD) or a ROM.

The image processing unit 104 is a processor that performs various image processings on the image data stored in the nonvolatile memory 103 or a recording medium 108, an image signal acquired via the external I/F 109, image data acquired via the communication I/F 110, and the like, based on the control of the CPU 101. Image processing performed by the image processing unit 104 includes A/D conversion, D/A conversion, encoding, compressing, decoding, enlarging/reducing (resizing), perspective projection transformation, noise reduction, and color conversion of image data, and the like. The image processing unit 104 may be configured as a circuit block to dedicatedly perform specific image processing. Depending on the type of image processing, the CPU 101 may perform image processing in accordance with a program, without using the image processing unit 104. The image processing unit 104 may also be contained in the CPU 101. The image processing unit 104 may also be implemented, for example, by a graphics processing unit (GPU). The GPU may be provided separately from the CPU 101 and may also be mounted on the same chip as that for the CPU 101.

The display 105 displays an image, a graphical user interface (GUI) screen formed as a GUI, and the like, based on the control of the CPU 101. The CPU 101 generates a display control signal in accordance with a program and performs control of the components of the display control apparatus 100 to generate an image signal for displaying the image on the display 105 and output the image signal to the display 105. The display 105 displays video based on the output image signal. The configuration of the display control apparatus 100 itself may be limited to components up to an interface for outputting an image signal for displaying the image on the display 105, and an external monitor (such as a TV set) may be used as the display 105.

The operation unit 106 is an input device for receiving a user operation, the input device including a text information input device such as a keyboard, a pointing device such as a mouse or a touch panel, a button, a dial, a joystick, a touch sensor, a touch pad, and the like.

The operation unit 106 is a user interface through which selecting and inputting a display method for image data stored in the recording medium 108 is available. The display method may be selected at least from fish-eye displaying for a fish-eye image itself and perspective projection transformation display (VR display) in which perspective projection transformation is applied to a fish-eye image.

The touch panel 106a is an input device in a planar form laid on top of the display 105 and configured to output coordinate information in accordance with a position where a touch is performed.

The recording medium I/F 107 allows the recording medium 108 such as a memory card, a CD, or a DVD to be attached thereto and reads out data from the attached recording medium 108 and writes data to the recording medium 108, based on the control of the CPU 101.

The external I/F 109 is an interface for inputting and outputting an image signal and an audio signal in such a manner as to be connected to an external apparatus with a cable or wirelessly.

The communication I/F 110 is an interface for transmitting various pieces of data for a file, a command, or the like in such a manner that communication with the external apparatus is performed directly or through the Internet.

The audio output unit 112 outputs sound of a moving image or music data, operation sound, incoming call sound, various notification sounds, and the like. The audio output unit 112 includes an audio output terminal to which an earphone or the like is connected and a speaker; however, audio output may be performed through wireless communication or the like.

The display device may be a head-mount display or augmented realty (AR) glasses. In the case of a head-mount display, image processing may be performed on an image to be displayed on the display such that a user recognizes the image as a planar image. For example, a fish-eye image is transformed into a planar image by perspective projection transformation, image processing is thereafter performed such that the user sights the image as a planar image, and the planar image is displayed on a display for the right eye and a display for the left eye.

An inertia measurement unit 113 is a sensor for detecting the position or the posture of the display control apparatus 100. The inertia measurement unit 113 has an inertia measuring device (inertia measurement unit: IMU) composed of an inertia sensor such as an acceleration sensor or an angular acceleration sensor. The inertia measurement unit 113 is used to acquire information regarding the position and posture of the user, and the CPU 101 acquires the information regarding the position and the posture of the user from the inertia measurement unit 113. The inertia measurement unit 113 may detect only the posture information, may detect only the position information, and may detect both of the posture information and the position information. That is, at least one of the posture information and the position information may be detected. The inertia measurement unit 113 may include a magnetic field sensor that is a sensor for detecting the bearing of the display control apparatus 100. The CPU 101 acquires information regarding the bearing of the display control apparatus 100 from the magnetic field sensor.

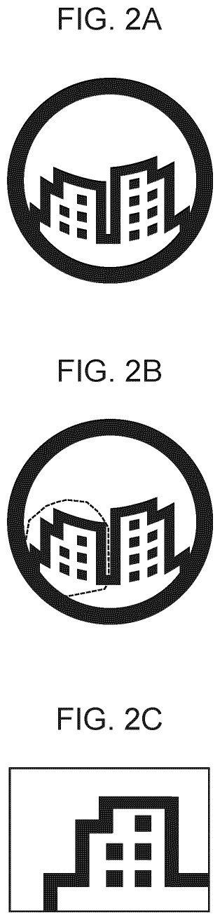

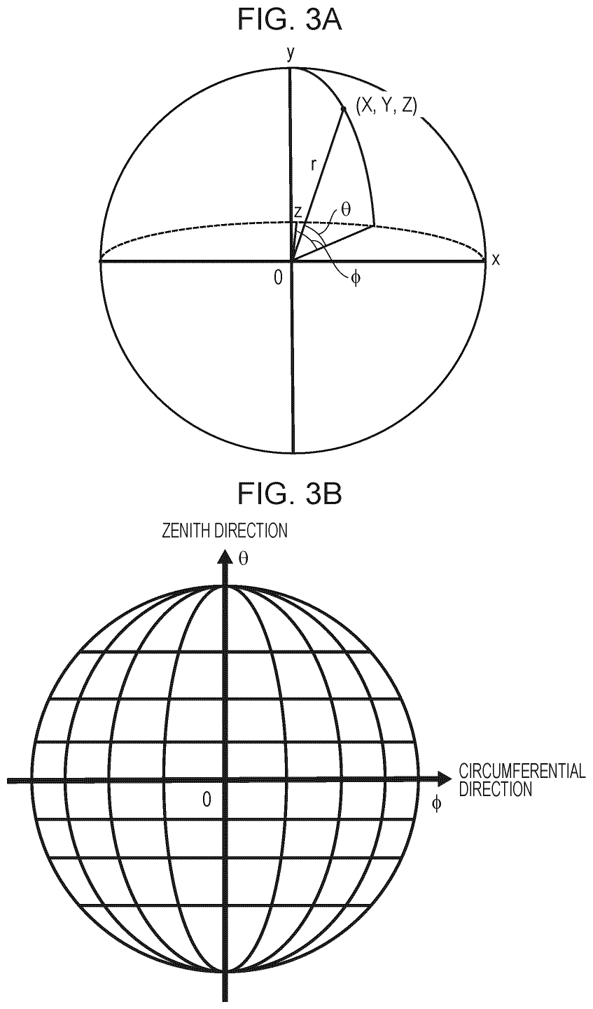

The image processing unit 104 includes a perspective projection transformation processing unit 104a. The perspective projection transformation processing unit 104a performs perspective projection transformation if the user selects VR display of image data stored in the recording medium 108 by using the operation unit 106. The perspective projection transformation is performed in such a manner that a viewing angle is set, thus generating an image by transforming a partial area of a captured image. With reference to FIGS. 2A to 3B, a method for generating a perspective projection transformation image according to Embodiment 1 will be described in detail. A case where a hemispherical image is captured is taken as an example.

FIG. 2A is a view illustrating an image captured if a fish-eye lens is used for an imaging device according to Embodiment 1. As illustrated in FIG. 2A, image data stored in the recording medium 108 forms an image distorted and cut circularly. For example, performing the perspective projection transformation on a partial area of the image, for example, an area surrounded by the dotted line in FIG. 2B enables display as in FIG. 2C to be performed, the display being equivalent to display viewed by the user with a HMD.

The perspective projection transformation processing unit 104a first draws a hemisphere as illustrated in FIG. 3A by using a three-dimensional computer graphic controller library or the like and attaches a fish-eye image to the inside of the hemisphere. The three-dimensional computer graphic controller library is, for example, open graphics library for embedded systems (Open GL ES).

In attaching the fish-eye image to the inside of the hemisphere, the fish-eye image is applied, for example, to a coordinate system composed of a vertical angle θ with respect to an axis in a zenith direction of the captured image and a horizontal angle φ around the axis in the zenith direction, as illustrated in FIG. 3B. At this time, if the range of the viewing angle of the fish-eye image is 180 degrees, the vertical angle θ and the horizontal angle φ are in a range from −90 degrees to 90 degrees. The coordinate value (θ, φ) of the fish-eye image can be associated with points on a surface of a sphere illustrated in FIG. 3A and representing a hemispherical image. Relationships between the fish-eye image illustrated in FIG. 3A and the two-dimensional coordinate can be expressed with (Formula 1), (Formula 2), and (Formula 3), where the center of the hemisphere is 0, the three-dimensional coordinate on the spherical surface is (X, Y, Z), and r is the radius of the hemisphere. Attaching the fish-eye image to the inside of the hemisphere based on the correspondence of the coordinates expressed by these formulas enables a hemispherical image to be generated on the three-dimensional virtual space.

$$X = r cos ( θ ) sin ( φ ) \# ( Formula 1 ) \qquad ( Formula 1 )$$

$$Y = r sin ( θ ) \# ( Formula 2 ) \qquad ( Formula 2 )$$

$$Z = r cos ( θ ) cos ( φ ) \# ( Formula 3 ) \qquad ( Formula 3 )$$

To generate the spherical image, fish-eye images covering 180 degrees in front of and 180 degrees behind the user are acquired, hemispherical images are generated by the aforementioned means and combined together. The 360-degree spherical image can thereby be generated.

As described above, the spherical image and the hemispherical images are images attached in such a manner as to cover the spherical surface. Accordingly, if the images are intact, the images do not serve as an image viewed by the user with the display control apparatus 100.

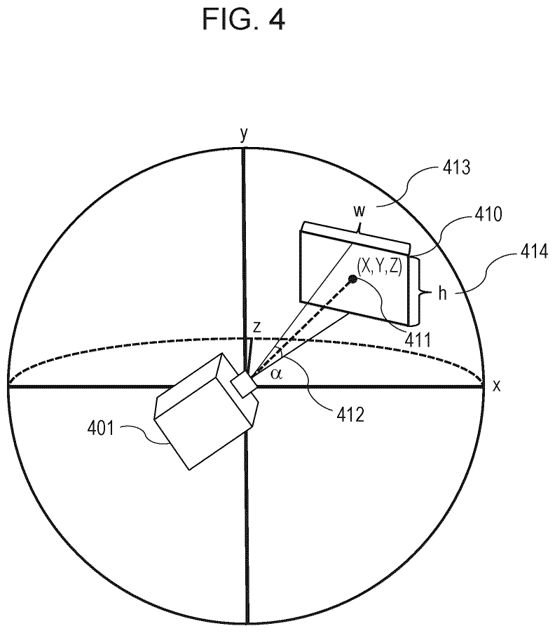

FIG. 4 is a view illustrating a positional relationship between a virtual camera 401 on the three-dimensional virtual space in the hemispherical image and an area 410 for deciding an area to undergo the perspective projection transformation. The virtual camera 401 corresponds to the position of the point of view of the user looking at the hemispherical image displayed as the three-dimensional solid hemisphere. The area 410 is decided depending on the range of the viewing angle of the virtual camera, with respect to the direction of the virtual camera that is decided based on the three-dimensional coordinate (X, Y, Z) 411 on the spherical surface. The image on the area on the spherical surface included in the area 410 viewed from the virtual camera 401 undergoes the perspective projection transformation and is then displayed on the display 105. In this embodiment example, an area to undergo the perspective projection transformation serves as a viewing range, and the viewing range is changed by changing the orientation of the virtual camera 401 in response to the user operating the operation unit 106. The viewing area corresponds to a display range displayed on the display 105. The viewing area is enlarged or reduced by changing a viewing angle α 412, in a vertical direction, of the virtual camera 401 in response to the user operating the operation unit 106. The enlargement/reduction has a correlation in which the smaller the viewing angle α 412 becomes, the more largely the VR display is displayed. Further, w413 and h414 in FIG. 4 respectively correspond to the horizontal resolution of the display 105 and the vertical resolution of the display 105.

VR content is a hemispherical fish-eye image in the description in this embodiment example; however, the VR content is not limited to this example as long as a photograph or video serves as VR content. For example, an equidistant cylindrical image transformed from a fish-eye image may be used.

If the operation unit 106 includes the touch panel 106a, the CPU 101 is able to detect the following operations or the states of the touch panel 106a.
A finger or a stylus pen that has not been in contact with the touch panel 106a newly becomes in contact with the touch panel 106a, that is the start of touch (hereinafter, referred to as a touch-down).
A finger or a stylus pen is in contact with the touch panel 106a (hereinafter, referred to as a touch-on).
A finger or a stylus pen is moving while in contact with the touch panel 106a (hereinafter, referred to as a touch-move).
A finger or a stylus pen that has been in contact with the touch panel 106a is lifted off from the touch panel 106a, that is the end of touch (hereinafter, referred to as a touch-up).
Nothing is in contact with the touch panel 106a (hereinafter, referred to as a touch-off).

In response to the detection of a touch-down, the touch-on state is simultaneously detected. As long as no touch-up is detected after the touch-down, the touch-on typically continues to be detected. The detection of a touch-move also corresponds to a touch-on detection state. If a touch-on is detected, but if a touch position is not moved, the touch-move is not detected. After a touch-up of all of fingers or a stylus pen in contact is detected, the state becomes a touch-off state.

These operations and states and a position coordinate of the finger or the stylus pen in contact with the touch panel 106a are reported to the CPU 101 via the internal bus 150, and the CPU 101 determines what kind of operation (touch operation) is performed on the touch panel 106a, based on the reported information. Regarding the touch-move, the moving direction of the finger or the stylus pen moving on the touch panel 106a is also determinable for each of a vertical component and a horizontal component on the touch panel 106a, based on a change in a position coordinate. If a touch-move in a predetermined distance or longer is detected, it is determined that a sliding operation has been performed. An operation in which a finger is quickly moved by some distance while keeping in contact with the touch panel 106a and is lifted off is referred to as a flick. In other words, the flick is an operation in which the finger is slid over the touch panel 106a in a flipping manner. If a touch-move by the predetermined distance or longer at a predetermined speed or higher is detected, and if a touch-up is detected in this state, it is determinable that a flick has been performed (it is determinable that a flick has been performed subsequently to the sliding operation). Further, a touch operation in which touches at a plurality of points (for example, two points) are simultaneously performed and touch positions are made closer to each other is referred to as a pinch-in, and a touch operation in which the touches are performed simultaneously and the touch positions are made far away from each other is referred to as a pinch-out. The pinch-out and the pinch-in are collectively referred to as a pinch operation (or simply a pinch). As the touch panel 106a, any of touch panels based on various systems may be used, such as a resistive system, a capacitive system, a surface acoustic wave system, an infrared light system, an electromagnetic induction system, an image recognition system, and an optical sensor system. Depending on the system, a touch is detected based on a touch on the touch panel or based on approach of a finger or a stylus pen to the touch panel. Any system may be used.

For the embodiment described above, the case where the present disclosure is applied to a smartphone has been described as an example; however, the present disclosure is not limited to this. The present disclosure may thus be applied to an imaging device such as a digital camera. The present disclosure is thus also applicable to a case where a captured image recorded in a recording medium, such as a memory card, that is readable by the digital camera is reproduced and displayed on the display such as a rear LCD display of the digital camera. Further, the present disclosure may be applied to a personal computer, a tablet terminal, a portable image viewer, a printer with a display, a digital photo frame, a music player, a gaming machine, and an electronic book reader. The present disclosure may be applied to a head-worn display device worn on the head of the user, such as a HMD or AR glasses.

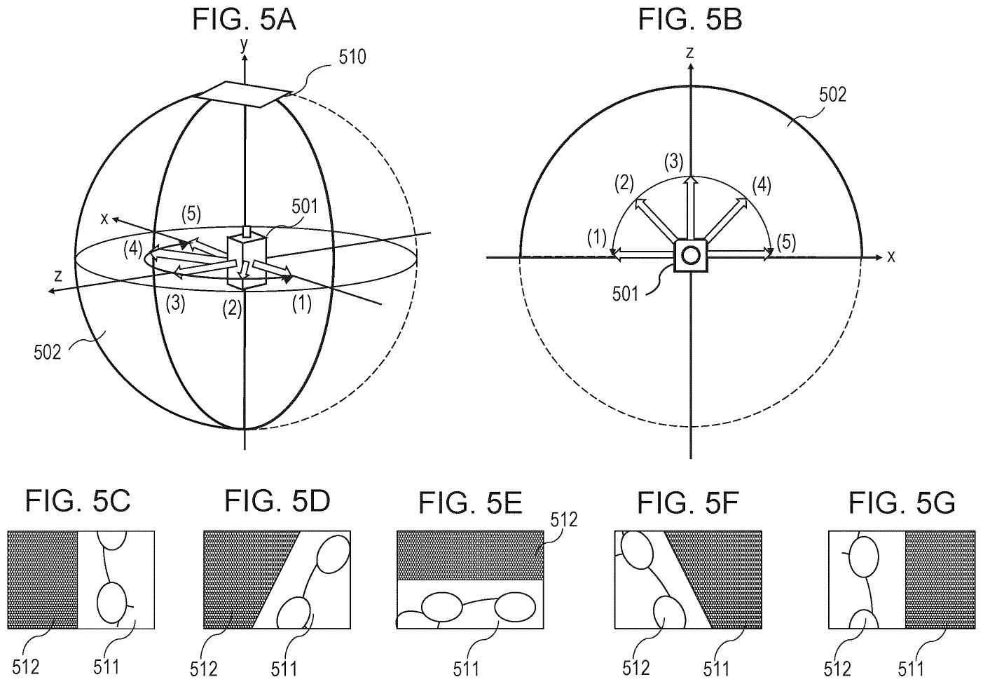

An example of the embodiment will be described based on the following condition: if VR content is a hemispherical fish-eye image when the perspective projection transformation processing unit 104a of the display control apparatus 100 performs the perspective projection transformation, the perspective projection transformation is performed on an area including particularly an upper end portion of a captured image as a viewing area. FIGS. 5A to 5G are views illustrating the condition.

FIG. 5A is a view in which a hemisphere 502 is drawn in an area surrounded by solid lines on the three-dimension and a fish-eye image is attached to the inside thereof. In FIG. 5A, the fish-eye image is thus drawn on an inner surface of the hemisphere 502 located in a positive direction of a z axis from an xy plane. FIG. 5A illustrates a state where a virtual camera 501 is disposed at the three-dimensional center position (0, 0, 0) and faces an upper portion along a y axis in the three-dimension. A viewing area 510 is disposed in a location orthogonal to the y axis. The hemisphere 502 has a radius of 1. FIG. 5B is a top view of FIG. 5A. FIG. 5C is a view generated as the result of the perspective projection transformation after the virtual camera 501 in FIG. 5A is rotated around the y axis (typically, referred to as panning rotation) in the state where the virtual camera 501 faces the upper portion along the y axis. FIGS. 5C, 5D, 5E, 5F, and 5G respectively correspond to arrows (1), (2), (3), (4), and (5) in FIG. 5A, and the arrows point respective lower portions of images after the perspective projection transformation. References (1), (2), (3), (4), and (5) in FIG. 5A respectively correspond to those in FIG. 5B.

As illustrated in FIG. 5E, if the virtual camera 501 faces the upper portion in the direction along the y axis, the viewing area for the perspective projection transformation includes a captured-image portion 511 and an exo-captured-image portion 512. A plurality of ways of expressing the exo-captured-image portion 512 are conceivable, but the exo-captured-image portion 512 is displayed in black in this example. If panning rotation of the virtual camera 501 is performed in this condition, the captured-image portion 511 and the exo-captured-image portion 512 are displayed on the display 105 in such a manner as to be rotated and transit on the VR display, as illustrated in FIGS. 5C, 5D, 5E, 5F, and 5G.

It is conceivable that the transition of the rotation state of the captured-image portion 511 and the exo-captured-image portion 512 in FIGS. 5C, 5D, 5E, 5F, and 5G arises with drastic changes in the image displayed on the display 105, which leads to image visibility deterioration for the user.

In addition, if the user inputs the panning rotation through two-dimensional input such as a touch-move on the touch panel 106a, instead of three-dimensional input, the input is required to be replaced with three-dimensional input onto the hemisphere before the perspective projection transformation. In this case, a conceivable way of panning rotation is that a horizontal axis for the two-dimensional coordinate on the fish-eye image is moved, and the position thereof is transformed into a three-dimensional coordinate. With reference to the coordinate system in which the fish-eye image in FIG. 3B is associated with a vertical angle and a horizontal angle of the three-dimensional coordinate on the spherical surface, the closer the horizontal angle φ associated with the panning rotation to the axis, in the zenith direction, of the fish-eye image, the larger the gauge of the fish-eye image. In particular, the closer to an end in the zenith direction along the axis, the more notable the larger gauge. Accordingly, if the panning rotation is performed of the virtual camera 501 in the condition in FIG. 5C in response to the input on the two-dimensional coordinate, the degree of rotation becomes larger particularly in the ranges in FIGS. 5D, 5E, and 5F, and moving to a desired position is considered to be difficult for the user.

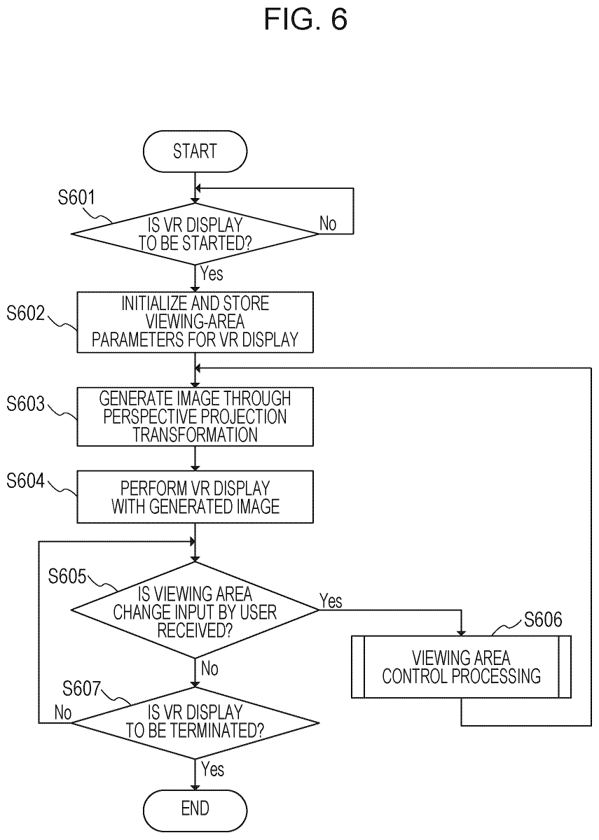

As processing to address the issue described above, example processing for putting viewing area restriction on an upper end portion and a lower end portion of a captured image as VR content will be described by using FIGS. 6 to 9B. The processing is the feature of the present disclosure. The upper end portion of the captured image as the VR content is an area at least including an upper end position of the captured image as the VR content, and the lower end portion of the captured image as the VR content is an area at least including a lower end position of the captured image as the VR content.

FIG. 6 illustrates a flow in which the VR content undergoes the perspective projection transformation and VR display to thereby receive changing of a viewing area. If an image made displayable in VR display through perspective projection transformation of a fish-eye image or the like is displayed on the display 105, or if user operation is received to display the image, the display control apparatus 100 performs processing.

If the CPU 101 receives the start of VR display from the operation unit 106 through a user operation in step S601, the CPU 101 proceeds to step S602. If the CPU 101 does not receive the start of VR display, the CPU 101 returns to step S601. The selection of the start of VR display may be received for an image that is being displayed as a fish-eye image on the display 105 and that is displayable in the VR display. Alternatively, when an image to be displayed on the display 105 is selected, displaying method selection of whether to display the image as a fish-eye image or in the VR display may be received.

In step S602, the CPU 101 initializes and stores viewing area parameters for deciding a viewing area in the VR display and proceeds to step S603. In this embodiment example, the viewing area parameters are a coordinate of the center of the viewing area in the three-dimensional coordinate system in performing the perspective projection transformation or a two-dimensional coordinate in the fish-eye image as well a viewing angle in the vertical direction in performing the perspective projection transformation (the viewing angle α 412 in FIG. 4). Among three-dimensional coordinates in the fish-eye image, a coordinate to correspond to the center of the viewing area in performing the perspective projection transformation is a coordinate 411 in FIG. 4 and is hereinafter referred to as a viewing-area center coordinate. In addition, a two-dimensional viewing-area center coordinate on the fish-eye image and the viewing angle in the vertical direction in performing the perspective projection transformation are stored in this embodiment example. In initializing the viewing area parameters, for example, any value may be used, or preceding parameter values in performing the perspective projection transformation may also be used.

In step S603, the CPU 101 reports the fish-eye image and the viewing area parameters to the perspective projection transformation processing unit 104a, instructs the perspective projection transformation processing unit 104a to perform the perspective projection transformation, and proceeds to step S604. The perspective projection transformation processing unit 104a performs the perspective projection transformation on the fish-eye image in accordance with the instruction and generates an image for performing the VR display. Processing for matching the horizontal and vertical resolutions of the generated image with the horizontal and vertical resolutions of the display 105 may be performed by the perspective projection transformation processing unit 104a, or resizing or the like included in the image processing unit 104 may be used.

In step S604, the CPU 101 receives the generated image, displays the image on the display 105, and proceeds to step S605.

In step S605, the CPU 101 determines whether a viewing area change is received from the operation unit 106 through a user operation. If the CPU 101 determines that a viewing area change is received, the CPU 101 proceeds to step S606. If the CPU 101 does not determine that a viewing area change is received, the CPU 101 proceeds to step S607. For example, if a touch-move is performed on the touch panel 106a for the VR display, or if the touch panel 106a is pressed down in a state where direction key operations are assigned to the operation part 106c and the operation part 106d, the CPU 101 may determine the operation represents a viewing area change accompanied by position movement. If a pinch-in or a pinch-out is performed on the touch panel 106a for the VR display, the CPU 101 may determine that the operation represents a viewing area change accompanied by enlargement/reduction. If operations for changing enlargement/reduction levels are assigned to the operation part 106c and the operation part 106d, and if the operation part 106c or the operation part 106d is pressed down, the CPU 101 may determine that the pressing down represents a viewing area change accompanied by the enlargement/reduction.

In step S606, the CPU 101 decides the viewing area by using viewing area control processing (described later), based on the user operation in step S605. After deciding the viewing area, the CPU 101 proceeds to step S603. The CPU 101 performs the perspective projection transformation and updates the VR display.

If the CPU 101 determines that the termination of the VR display is received from the operation unit 106 through a user operation, the CPU 101 terminates the processing in step S607. If the CPU 101 does not determine that the termination of the VR display is received, the CPU 101 proceeds to step S605 and continues the VR display state. In terminating the processing, the CPU 101 may cause the display state to return to a state where the fish-eye image of an image being in VR display is displayed or where the way of image displaying is selectable. For example, it is conceivable that receiving the user operation performed on the operation part 106b causes the processing to be terminated accompanied by powering off processing and receiving a user operation on the operation part 106e causes the processing to be terminated accompanied by transition to the home screen.

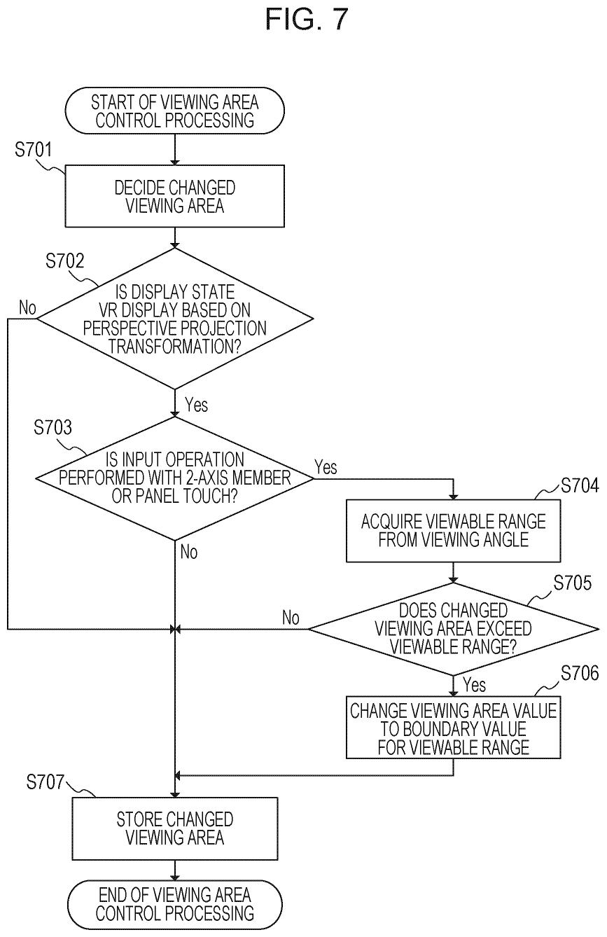

Subsequently, a specific embodiment example of the viewing area control processing in step S606 in FIG. 6 will be described by using FIGS. 7 to 9B.

FIG. 7 illustrates a flow of processing for putting viewing area restriction on the upper end portion and the lower end portion of the captured image as VR content.

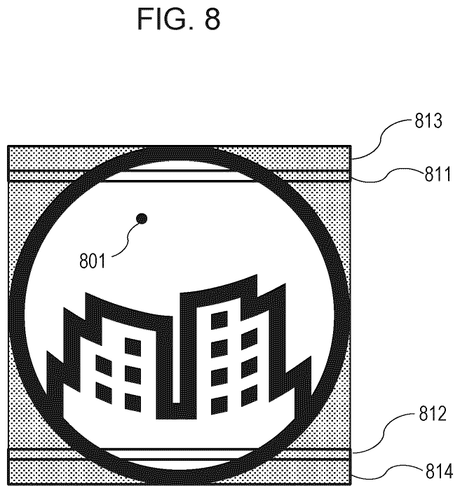

FIG. 8 is a view illustrating ranges of a hemispherical fish-eye image as VR content on which viewing area restriction is put (hereinafter, referred to as a restricted viewing range). The restriction is put on each area corresponding to the restricted viewing range to prevent the area from including a viewing-area center coordinate corresponding to the center coordinate of a display area to be displayed on the display 105. A method for deciding the restricted viewing range will be described later. Since the restriction is put on the upper and end portions, a restricted viewing range 811 and a restricted viewing range 812 are paired, and a restricted viewing range 813 and a restricted viewing range 814 are paired. The restricted viewing ranges 811 to 814 are enclosed in boxes. Further, the restricted viewing range 811 and the restricted viewing range 813 may overlap with each other, and the restricted viewing range 812 and the restricted viewing range 814 may also overlap with each other.

The restricted viewing range may also overlap with a viewing area for the perspective projection transformation. In this embodiment example, restriction is put on a two-dimensional coordinate in the fish-eye image yet to be transformed to a coordinate to correspond to the center of the viewing area in performing the perspective projection transformation in the three-dimension. For example, if the restricted viewing range 811 and the restricted viewing range 813 are set as the restricted viewing ranges, processing is performed to prevent a viewing-area central coordinate 801 from being set within the restricted viewing ranges 811 and 813. The restriction may also be put on a viewing area in the three-dimensional coordinate system transformed from the two-dimensional coordinate system to be in the state where the fish-eye image is attached to the hemisphere.

In FIG. 8, restriction is put on the upper end portion and the lower end portion of the fish-eye image in an area where the viewing-area center coordinate is movable, but restriction is not put on an area where the viewing-area center coordinate is movable in a right end portion and a left end portion. Restriction may be put on the area where the viewing-area center coordinate is movable in the right end portion and the left end portion, as necessary. For example, a restricted area in the area where the viewing-area center coordinate is movable may be provided in the right end portion and the left end portion, the restricted area being narrower than the restricted area in the area where the viewing-area center coordinate is movable in each of the upper end portion and the lower end portion.

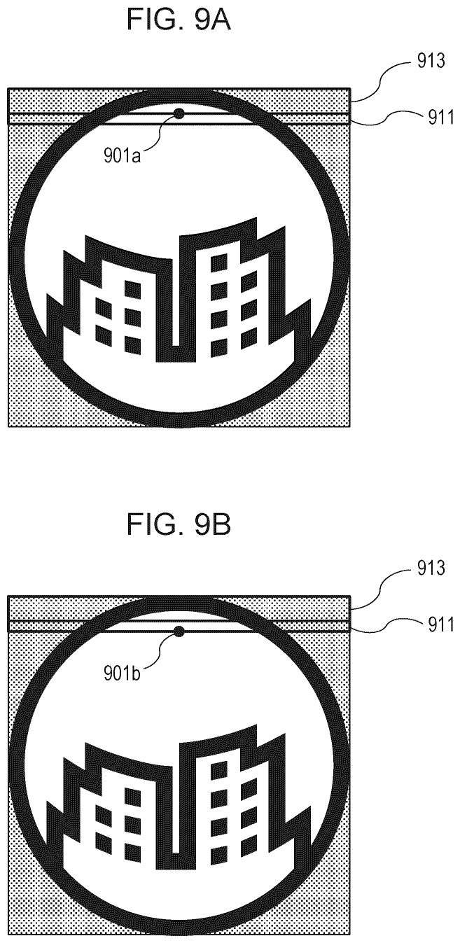

FIGS. 9A and 9B are views respectively illustrating the positions of viewing-area central coordinates 901a and 901b after a restricted viewing area is changed from a restricted viewing range 911 to a restricted viewing range 913 by enlargement/reduction.

The processing in FIG. 7 is started in response to the viewing area control processing in step S606 in FIG. 6.

In step S701, the CPU 101 decides a viewing area after the change based on the viewing area parameters changed in accordance with the user operation received in step S605 in FIG. 6. For example, if the received user operation is an operation for moving the location of the viewing area, the viewing-area center coordinate is changed. If the received user operation is an enlargement/reduction operation, the viewing angle in the vertical direction in performing the perspective projection transformation is changed.

In step S702, the CPU 101 determines whether the current display state is the VR display. If the current display state is the VR display, the CPU 101 proceeds to step S703. If the current display state is not the VR display, the CPU 101 proceeds to step S707. This step is useful in the following condition: the restricted viewing area is not necessary when the display state is in a mixed state of fish-eye image display, the VR display, and the like, and, for example, this flow is used if an operation is performed when an enlarged fish-eye image is displayed. Accordingly, if this step is to be performed necessarily only in the VR display state in the flow, this step may be omitted.

In step S703, the CPU 101 determines whether the input received in step S605 in FIG. 6 from the operation unit 106 through the user operation is an operation performed two-dimensionally and functioning as a direction key on the touch panel 106a, the operation part 106c, the operation part 106d, or the like. If the CPU 101 determines that the input is a two-dimensionally performed operation, the CPU 101 proceeds to step S704. If the CPU 101 determines that the input is not a two-dimensionally performed operation, the CPU 101 proceeds to step S707. Step S703 is useful if the restricted viewing area is unnecessary under the following condition: if a three-dimensionally performed operation based on input from a gyro sensor that detects the posture of the display control apparatus 100 is available, that is, if the center of the viewing area in the three-dimensional coordinate information is changeable through the three-dimensionally performed operation.

In step $704, the CPU 101 acquires a viewable range from the viewing angle in the vertical direction as the viewing area parameter. The viewable range is able to be set in accordance with a formula using a viewing angle, in the vertical direction, to the vertical axis in the fish-eye image as a parameter, and ranges not included in the viewable range are the restricted viewing ranges 811 to 814 in FIG. 8 and the restricted viewing ranges 911 and 913 in FIGS. 9A and 9B. Specifically, zero is set as the center of the fish-eye image of the image along the vertical axis, boundary values in positive and negative directions of the vertical axis are calculated by using a formula including the constant value and using the viewing angle in the vertical direction as the parameter, and an area between the positive and negative boundary values is set as the viewable range. The larger the viewing angle in the vertical direction is, the closer to the center of the fish-eye image of the image along the vertical axis each boundary value becomes. The smaller the viewing angle in the vertical direction is, the closer to the image end of the vertical axis of the fish-eye image the boundary value becomes. If an acquirable viewing angle in the vertical direction is predetermined, a viewable range corresponding thereto may be stored in advance.

The range in the viewable range with respect to the axis in the vertical direction in the fish-eye has heretofore been described. A range with respect to the horizontal axis does not have to be set particularly. In the case where the range is set, for example, the width of the fish-eye image or an image capturing range of the fish-eye image may be set for the range.

If the viewing area after the change calculated in step S701 exceeds the viewable range in step S705, the CPU 101 proceeds to step S706. If the viewing area after the change does not exceed the viewable range, the CPU 101 proceeds to step S707. The exceeding of the viewing area over the viewable range has been described regarding the restricted viewing range. The exceeding means that the viewing-area center coordinate as the viewing area parameter on the fish-eye image exceeds one of the boundary values of the viewable range.

In step S706, the CPU 101 changes the viewing-area center coordinate as the viewing area parameter on the fish-eye image to the boundary value for the viewable range. If the viewing area exceeds a positive boundary value for the viewable range, the CPU 101 changes a vertical-axis-related value of the viewing-area center coordinate to the positive boundary value. If the viewing area exceeds a negative boundary value, the CPU 101 changes a vertical-axis-related value of the viewing-area center coordinate to the negative boundary value. That is, restriction is put to prevent the viewing-area center coordinate from moving to the upper end position or the lower end position of the fish-eye image.

Further, if the viewing angle in the vertical direction is changed in step S701, the viewable range is also changed from the viewing range as the viewing area before the change in step S704. It is conceivable that the boundary value of the viewable range after the change becomes closer to the center of the image due to the change of the viewable range. For example, in FIG. 9A, the viewing-area central coordinate 901a is located at the position of the boundary value of the restricted viewing range 913 before the change (also means the boundary value of the viewable range). If a user operation for reducing the image with the operation unit 106, that is, if an operation for making the viewing area larger is received from the position, the restricted viewing range after the change is changed to the restricted viewing range 911. In this case, as in FIG. 9B, the vertical-axis-related value is changed to locate the viewing-area center coordinate at the position of the boundary value of the restricted viewing range 911 and thus becomes the viewing-area central coordinate 901b. In contrast, if a user operation for enlarging the image performed with the operation unit 106 is received in the state in FIG. 9B, the viewing-area center coordinate after the change may be changed to the position corresponding to the boundary value of the restricted point-of-view range after the change because the viewing-area center coordinate before the change is the boundary value of the restricted viewing range before the change. That is, if an operation for making the viewing area smaller is received, the state in FIG. 9B may be changed to the state in FIG. 9A.

In step S707, the CPU 101 stores the viewing area after the change and terminates the viewing area control processing.

If the viewing area is changed through a three-dimensionally performed operation such as an operation based on the posture of the display control apparatus 100, the restricted viewing range does not have to be provided.

### Embodiment 2

Subsequently, a display device and processing according to a second embodiment of the present disclosure will be described. In this embodiment, the configuration of the display control apparatus 100 is the same as that in Embodiment 1, and thus description thereof is omitted.

An example of processing for reducing a moving amount (the amount of change) in the horizontal direction in a partial range of the upper and lower ends of a captured image as VR content will be described with reference to FIGS. 6, 10, and 11, the processing is a feature of the present disclosure.

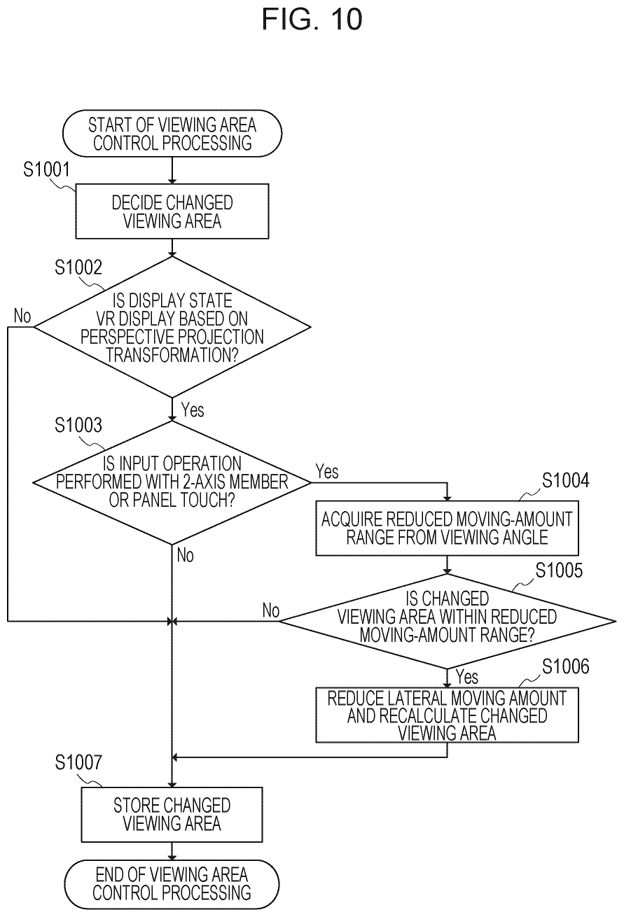

The flowchart in FIG. 6 is the same as in Embodiment 1, and thus description thereof is omitted. For the flowchart in FIG. 10, description of steps common to those in the flowchart in FIG. 7 described for Embodiment 1 is omitted, and only different points will be described.

FIG. 10 is a flowchart of the processing for reducing the moving amount in the horizontal direction in the partial range of the upper and lower ends of the captured image for the VR content.

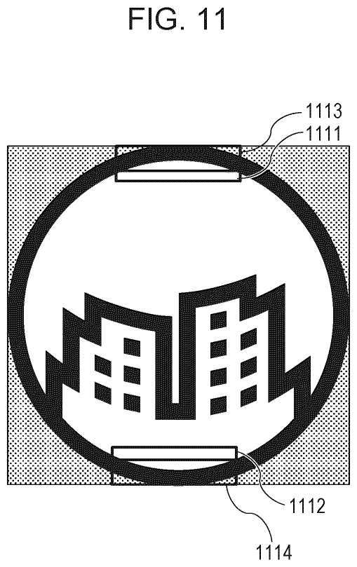

FIG. 11 is a view illustrating ranges 1111 to 1114 where the moving amount in the horizontal direction is to be reduced in a hemispherical fish-eye image as VR content (hereinafter, referred to as reduced moving-amount ranges). Since restriction is put on the upper and lower end portions as the reduced moving-amount ranges, the range 1111 and the range 1112 are paired, and the range 1113 and the range 1114 are paired, the ranges 1111 to 1114 being enclosed in boxes. Further, the range 1111 and the range 1113 may overlap with each other, and the range 1112 and the range 1114 may also overlap with each other.

In addition, in this embodiment example, each reduced moving-amount range is provided at the two-dimensional coordinates of the fish-eye image yet to be transformed on the three-dimension into the coordinate to correspond to the center of the viewing area in performing the perspective projection transformation. The range may be provided in the three-dimensional coordinate system transformed from the two-dimensional coordinate system, the three-dimensional coordinate system being in the state where the fish-eye image is attached to the hemisphere.

The processing in the flow in FIG. 10 is started in response to the viewing area control processing in step S606 in FIG. 6.

Steps S1001 to 1003 are common to steps S701 to 703 in FIG. 7 in Embodiment 1.

In step S1004, the CPU 101 acquires a reduced moving-amount range from the viewing angle in the vertical direction as the viewing area parameter. The reduced moving-amount range with respect to the vertical axis in the fish-eye image is common to the restricted viewing range described for Embodiment 1. A range with respect to the horizontal axis has positive and negative boundary values with zero as the center of the fish-eye image of the image along the horizontal axis. The boundary values along the horizontal axis may be predetermined values or may be set from the viewing angle in the vertical direction in the same manner as for the boundary values along the vertical axis.

If the viewing area after the change calculated in step S1001 is within the reduced moving-amount range in step S1005, the CPU 101 proceeds to step S706. If the viewing area is not within the reduced moving-amount range, the CPU 101 proceeds to step S707.

In step S1006, the CPU 101 reduces the moving amount of the viewing-area center coordinate as the viewing area parameter, with respect to the horizontal axis and recalculates the viewing area after the change. The moving amount to be reduced is calculated in accordance with a formula for reducing the moving amount such as by multiplying a predetermined numerical value of 1 or smaller.

Step S1007 is common to step S707 in FIG. 7 in Embodiment 1.

### Other Embodiments

The present disclosure may be implemented by performing the following processing. That is, in the processing, software (a program) that implements the functions of the embodiments described above is supplied to a system or an apparatus via a network or any of various storage media, and a computer (or a control unit, a MPU, or other devices) of the system or an apparatus reads out and runs program code. In this case, the program and the storage medium storing the program is included in the present disclosure.

The present disclosure has heretofore been described in detail based on the embodiments but is not limited to the specific embodiments. Various forms are included in the present disclosure without departing from the spirit of the disclosure. Part of the embodiments described above may appropriately be combined with another.

According to the present disclosure, even if the upper and lower ends of a captured image as VR content are included in a viewing area, the visibility of a user may be prevented from being deteriorated, and user operations for verifying the captured image and changing the viewing area may be performed easily.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-061802, filed Apr. 5, 2024, which is hereby incorporated by reference herein in its entirety.

What is claimed is:

1. An image processing apparatus comprising:
a processor; and
a memory storing instructions which, when executed by the processor, cause the image processing apparatus to:
execute receiving processing for receiving an operation of changing a display range for an image displayed on a display; and
execute display control processing for performing control based on the operation, the control being performed to transform an image of a predetermined range in a hemispherical image into a planar image and to display the planar image on the display, wherein in the display control processing, the control is performed to display, in the display range, an area included in the planar image and corresponding to a predetermined area at least including an upper end position or a lower end position of the hemispherical image but not to display the area at a position of a center of the display range.

2. The image processing apparatus according to claim 1, wherein
in the receiving processing, an operation performed with a touch panel or a button is received.

3. The image processing apparatus according to claim 1, wherein
in the receiving processing, an operation for changing a position of the display range or an operation for changing a size of the display range is received.

4. The image processing apparatus according to claim 1, wherein
in the display control processing, the hemispherical image is transformed into the planar image through perspective projection transformation.

5. The image processing apparatus according to claim 1, wherein
if the operation for changing a size of the display range is received in the receiving processing, a position of the display range and the size are changed in the display control processing not to display the area included in the planar image and corresponding to the predetermined area at least including the upper end position or the lower end position of the hemispherical image at the position of the center of the display range.

6. The image processing apparatus according to claim 1, wherein
in the display control processing, an amount of change in location of the display range based on the operation for changing the location of the display range is modified depending on a case where the area included in the planar image and corresponding to the predetermined area at least including the upper end position or the lower end position of the hemispherical image is being displayed on the display or a case where the area is not being displayed.

7. The image processing apparatus according to claim 6, wherein
in the display control processing, control is performed to make the amount of change in the location of the display range based on the operation for changing the location of the display range smaller in the case where the area included in the planar image and corresponding to the predetermined area at least including the upper end position or the lower end position of the hemispherical image is being displayed on the display than an amount of change in the location of the display range in the case where the area included in the planar image and corresponding to the predetermined area at least including the upper end position or the lower end position of the hemispherical image is not being displayed on the display.

8. The image processing apparatus according to claim 1, further comprising:
the display.

9. The image processing apparatus according to claim 1, wherein
the instructions, when executed by the processor, further cause the image processing apparatus to execute acquisition processing to acquire a fish-eye image, and
in the display control processing, the fish-eye image acquired in the acquisition processing is transformed into the planar image through perspective projection transformation and is displayed on the display.

10. The image processing apparatus according to claim 1, wherein
in the image displayed on the display, an area not corresponding to the planar image is displayed in a predetermined color.

11. The image processing apparatus according to claim 1, wherein
in the display control processing, the control is performed to display the planar image or a fish-eye image on the display, and
if the fish-eye image is to be displayed on the display, restriction is not put on a displayable range in an area included in the fish-eye image and corresponding to the predetermined area at least including the upper end position or the lower end position of the hemispherical image.

12. The image processing apparatus according to claim 1, wherein
in the display control processing, if the display range is changed based on a three-dimensionally performed operation, restriction is not put on a displayable range in the area included in the planar image and corresponding to the predetermined area at least including the upper end position or the lower end position of the hemispherical image.

13. The image processing apparatus according to claim 12, wherein
in the receiving processing, the operation for changing the display range is received in response to a change in a posture of a head-mount display including the display, and
in the display control processing, if the display range is changed based on the change in the posture of the head-mount display, restriction is not put on the displayable range in the area included in the planar image and corresponding to the predetermined area at least including the upper end position or the lower end position of the hemispherical image.

14. A control method of an image processing apparatus, comprising:
receiving of receiving an operation for changing a display range of an image displayed on a display; and
display controlling of performing control based on the operation, the control being performed to transform an image of a predetermined range in a hemispherical image into a planar image and to display the planar image on the display,
wherein in the display controlling, the control is performed to display, in the display range, an area included in the planar image and corresponding to a predetermined area at least including an upper end position or a lower end position of the hemispherical image but not to display the area at a position of a center of the display range.

15. A non-transitory computer readable medium that stores instructions wherein the instructions cause a computer to execute the control method according to claim 14.

16. An image processing system comprising:
a receiving device that receives an operation of changing a display range for an image displayed on a display device; and
a display control apparatus that performs control based on the operation, the control being performed to transform an image of a predetermined range in a hemispherical image into a planar image and to display the planar image on the display device, wherein
the display control apparatus performs the control to display, in the display range, an area included in the planar image and corresponding to a predetermined area at least including an upper end position or a lower end position of the hemispherical image but not to display the area at a position of a center of the display range.
